(19) United States
(12) Patent Application Publication
(10) Pub. No.: US 2010/0035555 A1
(43) Pub. Date: Feb. 11, 2010

(54) METHOD AND APPARATUS FOR IMPLEMENTING MULTI-CELL COOPERATION TECHNIQUES

(75) Inventors: Erdem Bala, Farmingdale, NY (US); Sung-Hyuk Shin, Northvale, NJ (US); Philip J. Pietraski, Huntington Station, NY (US); Kalpendu R. Pasad, Hicksville, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/533,314

(22) Filed: Jul. 31, 2009

Related U.S. Application Data
(60) Provisional application No. 61/087,454, filed on Aug. 8, 2008.
(60) Provisional application No. 61/086,362, filed on Aug. 5, 2008.

(51) Int. Cl. H04B 15/00

(52) U.S. Cl. 455/63.1

(57) ABSTRACT

A method and apparatus are provided for multi-cell cooperation when multiple cells are cooperating to transmit data to a plurality of wireless transmit/receive units (WTRUs), and each cell is using a common precoding matrix. The level of information exchanged among the cells may depend on the particular cooperation architecture. The cells may share information such as channel state information (CSI), a channel quality indicator (CQI), or both. The cells may share rank indications reported by the WTRUs. The cells may also share the data that is being transmitted to the WTRUs. The method and apparatus may also determine precoding vectors for closed-loop precoding; a CQI, CSI and rank, and distributed space-time/frequency coding with multi-cell cooperation. The method and apparatus may also perform hybrid automatic repeat request (HARQ) with multi-cell cooperation, and downlink control signaling.

### CROSS REFERENCE TO RELATED APPLICATIONS

This application claims the benefit of U.S. Provisional Application No. 61/087,454 filed Aug. 8, 2008 and U.S. Provisional Application No. 61/086,362 filed Aug. 5, 2008, which are incorporated by reference as if fully set forth.

### TECHNICAL FIELD

This application is related to wireless communications.

### BACKGROUND

Inter-cell interference is a fundamental limiting factor for wireless communications. The spectral efficiency of cell-edge wireless transmit/receive units (WTRUs) that experience high levels of interference may be significantly degraded.

FIG. 1 shows a first Node-B (Node-B1) and a second Node-B (Node-B 2), each residing in respective cells including respective WTRUs (WTRU 1 and WTRU 2).

There are two main architectures for cell cooperation. In the first architecture, cooperation may occur among the cells of a single Node-B. In this case, the Node-B is the central controller and large levels of cooperation may be achieved. For example, the first architecture may include remote radio units (RRUs), where the RRUs are connected to the single Node-B with fast links, as shown in FIG. 2. One or more RRUs may be used to create a cell.

Assuming there are N cells cooperating to transmit data to M WTRUs, the received signal, for a given WTRU, may be given as follows:

$$y = [ {H}_{1} … {H}_{N} ] [ \begin{matrix}{W}_{1} & … & 0 \\ & ⋱ & \\ 0 & & {W}_{N}\end{matrix} ] [ \begin{matrix}{s}_{1} \\ ⋮ \\ {s}_{N}\end{matrix} ] , \qquad Equation ( 1 )$$

Where H_{N} denotes the multiple-input multiple-output (MIMO) channel from the WTRU to the N′th cell, W_{N} denotes the precoding matrix used at the N′th cell, and s is the data vector. The power allocations are embedded in the precoding matrices. FIG. 1 depicts an example of such a cooperative configuration consisting of two cells.

In the second architecture, cooperation may occur among the cells of different Node-Bs. In this case, the level of cooperation depends on the capacity of the links over which the different Node-Bs communicate.

In order to reduce the detrimental effects of interference, several interference mitigation techniques have been proposed. Some of these techniques implement interference avoidance, while others are used to coordinate the transmission of neighboring cells to control interference.

Cell-cooperation is typically implemented by using multi-user (MU)-MIMO techniques. One such technique is referred to a zero-forcing beamforming (ZF) MU-MIMO. Assume that M RRUS, (e.g., relays), each with a single transmit antenna, cooperate to transmit to K WTRUs. This is equivalent to having a single transmitter with M antennas. Let sₖ be the data symbol that would be transmitted to the k^{th} user, and Pₖ be the power allocated for this user. The data symbol for each user is multiplied with a beamforming vector wₖ. Then, the transmitted signal from the Node-B is given as follows:

$${\sum }_{k = 1}^{K} \sqrt{{P}_{k}} {w}_{k} {s}_{k} . \qquad Equation ( 2 )$$

For user k, the received signal is:

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k} , \qquad Equation ( 3 )$$

where hₖ denotes the channel from the user k to the M RRUS. The first part of the received signal is the data stream transmitted to user k, the second part of the received signal is data transmitted to the other users, (i.e., inter-user or inter-stream interference), and the third part of the received signal is noise. In zero-forcing beamforming, the beamforming vectors are chosen such that

hₖwⱼ=0, and Equation (4)

k≠j. Equation (5)

This condition guarantees that the inter-user interference is completely canceled.

One way of accomplishing the zero inter-user interference condition is to compute the beamforming vectors from the pseudo-inverse of the composite channel matrix, where a composite channel matrix is defined as

H=[h₁ h₂ . . . h_{K}], Equation (6)

and the composite beamforming matrix is defined as

W=[w₁ w₂ . . . w_{K}], Equation (7)

Then, the zero inter-user interference condition could be satisfied if

W=H^{†}=H^{H}(HH^{H})⁻¹. Equation (8)

In a frequency division duplex (FDD) system, the channel vectors can be quantized and then fed back to the Node-B. In that case, due to the quantization error, the interference cannot be completely canceled.

One limiting factor in wireless communications is the performance of a physical downlink control channel (PDCCH). A PDCCH consists of one or more control channel elements (CCE). For example, a PDCCH can consist of 1, 2, 4 or 8 CCEs in release 8 (R8) LTE. A CCE consists of several resource elements, (i.e., subcarriers in an orthogonal frequency division multiplexing (OFDM) symbol. The resource elements of a CCE are distributed in frequency (subcarriers) and time (e.g., different OFDM symbols) to increase the diversity. Thus, unlike subcarriers that carry data, subcarriers that carry control information are not localized. The cyclic redundancy check (CRC) of a PDCCH is masked with the WTRU identity (ID), and the correct PDCCH is determined by blind detection.

Since interference cannot be completely canceled using existing techniques, it would be desirable to reduce the detrimental effects of interference using interference mitigation techniques such as interference avoidance or interference coordination. Furthermore, it would be desirable to use multi-cell cooperation techniques to improve the performance of PDCCHs by improving the link reliability or providing higher rates of data transmission through the support of transmission from multiple points.

### SUMMARY

A method and apparatus are provided for multi-cell cooperation when multiple cells are cooperating to transmit data to a plurality of WTRUs and each cell is using a common precoding matrix. The level of information exchanged among the cells may depend on the particular cooperation architecture. The cells may share information such as channel state information (CSI), a channel quality indicator (CQI), or both. The cells may share rank indications reported by the WTRUs. The cells may also share the data that is being transmitted to the WTRUs. The method and apparatus may also determine precoding vectors for closed-loop precoding, a CQI, CSI and rank, and distributed space-time/frequency coding with multi-cell cooperation. The method and apparatus may also perform hybrid automatic repeat request (HARQ) with multi-cell cooperation, and downlink control signaling.

To reduce the detrimental effects of interference, several interference mitigation techniques have been proposed. Some of these techniques implement interference avoidance while others are used to coordinate the transmission of neighboring cells to control interference. One method of interference coordination is called multi-cell MIMO where neighboring cells collaboratively transmit to the cell-edge WTRUs by using MIMO techniques. In this technique, if the perfect CSI of the WTRUs is available at the Node-B, inter-cell interference can be cancelled completely with zero-forcing beamforming. Several multi-cell MIMO techniques can be used to improve the control channel performance of cell-edge WTRUs.

### BRIEF DESCRIPTION OF THE DRAWINGS

A more detailed understanding may be had from the following description, given by way of example in conjunction with the accompanying drawings wherein:

FIG. 1 shows a sample cooperation scenario;

FIG. 2 is a diagram of a sample architecture with remote radio units;

FIG. 3 shows effective CQI;

FIG. 4 shows separate CQIs for the same resource block groups (RBGs) for different cooperating cells;

FIG. 5 shows separate CQIs for different RBGs for different cooperating cells;

FIG. 6 shows wideband CQI;

FIG. 7 shows sample periodic reporting mechanisms for rank;

FIG. 8 shows sample periodic reporting mechanisms for CSI/precoding matrix indicator (PMI) and CQI;

FIG. 9 shows sample periodic reporting mechanisms for different subbands;

FIG. 10 shows distributed space-frequency block coding (SFBC)/space-time block coding (STBC) in multi-cell cooperation;

FIG. 11 shows SFBC/STBC in multi-cell cooperation;

FIG. 12 is a diagram of spatial separation of control data for two different WTRUs;

FIG. 13 is a diagram of PDCCHs of different size for two WTRUs;

FIG. 14 is a diagram of transmission of the same PDCCH from cooperating cells;

FIG. 15 is a block diagram of separating the control data of different WTRUs with spreading codes;

FIGS. 16A and 16B show spreading in time/frequency;

FIG. 17 is a block diagram of a WTRU; and

FIG. 18 is a block diagram of a transmission point.

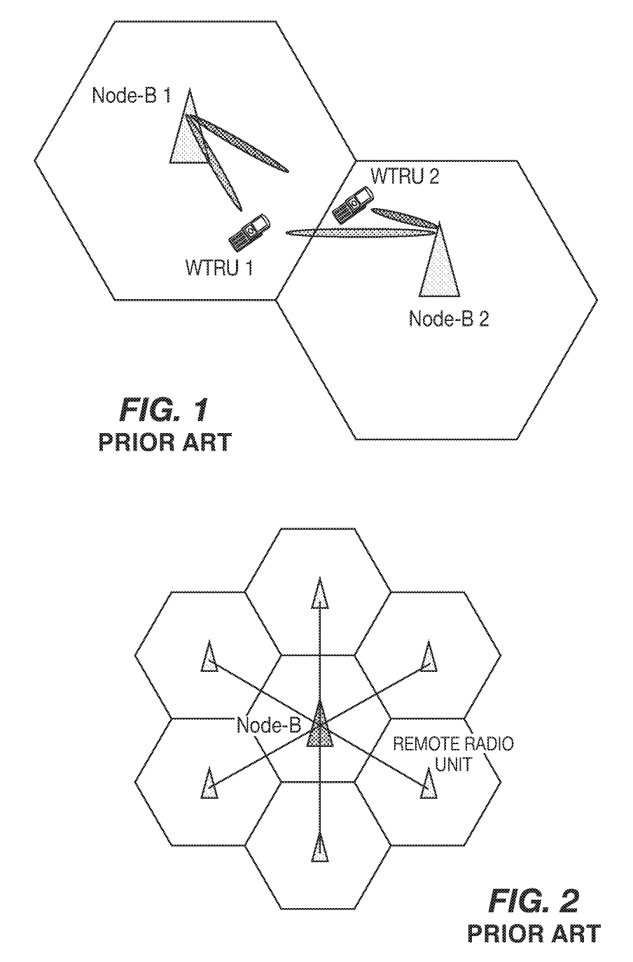

### DETAILED DESCRIPTION

When referred to hereafter, the terminology “wireless transmit/receive unit (WTRU)” includes but is not limited to a user equipment (WTRU), a mobile station, a fixed or mobile subscriber unit, a pager, a cellular telephone, a personal digital assistant (PDA), a computer, or any other type of user device capable of operating in a wireless environment.

When referred to hereafter, the terminology “Node-B” includes but is not limited to an evolved Node-B (eNodeB), a base station, a site controller, an access point (AP), or any other type of interfacing device capable of operating in a wireless environment.

Multiple cells may cooperate to transmit data to a plurality of WTRUs simultaneously. Each cell may use a precoding matrix W. The level of information exchange among the cells may depend on the particular cooperation architecture. The cells may share information such as the CSI, the CQI, or both. The cells may share rank indication reported by the WTRUs. The cells may share a combination of this information. The cells may also share the data that is required to be transmitted to the WTRUs.

Determination of the Precoding Vectors for Closed-Loop Precoding

The precoding vectors, W, may be determined in several different ways. A codebook may be used at the transmission side and the WTRU may select a preferred precoding vector from this codebook. Another approach may be to have the WTRU estimate the downlink (DL) channel and report the estimate back to the transmitter. The transmitter may then compute the precoding vectors by using the channel information. Alternatively, the transmitter may estimate the long-term DL channel characteristics from the uplink (UL) transmission and compute the precoding vectors.

Codebook Precoding

A codebook based approach may be used for multi-cell precoding. In a codebook based approach, the codebook may consist of unitary precoding matrices W. These matrices may also be non-unitary. The WTRU may select the preferred vector or vectors from the unitary matrices and send the indices of the selected vectors to the transmitter. The number of vectors selected for transmission may be equal to the rank, for example the number of transmission layers desired. A precoding vector may be selected for each transmission layer.

When W=[w₁ w₂], the WTRU may select w₁ or w₂ for data transmission from a given cell on a preferred set of subcarriers, (i.e., an RBG or subband). The remaining vector, or vectors, in this unitary matrix may be used by the same cell to transmit data to another WTRU on the same RBG. The WTRU may select and signal more than one vector so that multiple data streams may be precoded with the vectors.

A matrix may consist of a large number of vectors. A WTRU may not be able to exactly predict which vectors are going to be used for data transmission to other WTRUs in the same RBGs. For example, if a matrix consists of 16 vectors and the WTRU selects one of these vectors, any of the remaining 15 vectors may be used for another WTRU. The precoding vectors for co-scheduled WTRUs may be signaled to the WTRU so that an efficient receive filter may be designed; however, signaling of the precoding vectors for all co-scheduled WTRUs to the individual WTRUs increases DL control signaling overhead. Network coding for DL control signaling may be applied to reduce the signaling overhead. Alternatively, a dedicated reference signal (DRS) may be transmitted from each cooperating transmit site (such as, the eNodeB or the RRU), each transmit antenna port, or each sub-group of transmission (Tx) antenna ports.

The selection of the precoding vectors may be performed separately for each cell which is cooperatively transmitting to the WTRU. The selection may be performed by a central controller, for example, an eNodeB. If cooperation is performed among the cells of different eNodeBs, then the selection may be performed by the primary eNodeB or the individual eNodeBs.

In the UL, the WTRU may send the index of the precoding vector for some or all of the cooperating cells.

A single precoding vector, whose coefficients are distributed over the cooperating antennas, may be used. In this case, each cooperating cell may not use a separate precoding vector. Differences in path loss and shadowing from each cooperating cell may occur. Also, the size of the precoding vector may vary as the total size of the antennas change.

When two or more WTRUs are paired for simultaneous transmission in MU-MIMO mode by a cooperating cell in a RBG, the total transmission power may be divided among the WTRUs. In this case, the ratio of the power allocated to a WTRU may also need to be signaled. For example, if the codebook is W=[w₁ w₂] and two vectors are used for simultaneous transmission to two WTRUs, then signaling that there are two scheduled WTRUs may result in the power allocation information being learned by the WTRU (assuming equal power allocation among the two WTRUs), and the WTRU may know the interfering precoding vector.

Downlink Channel State Precoding

The precoding vectors may be determined by using the downlink channel state information. The WTRU may estimate the downlink channel, quantize it, and feed the quantized CSI back to the transmitter. Then, by using the channel information, the Node-B may compute the precoding matrices. Zero-forcing, or a similar approach, may be used.

To achieve optimal performance of the zero-forcing beamforming approach, perfect CSI for all users may be required at the base station. This may be achieved by the WTRU estimating the channel and feeding this information back to the Node-B. Due to practical limits on channel estimation and the capacity of the feedback channel, precise channel state may not be known by the Node-B. Instead, the estimated channel may be quantized according to a given codebook, and the index from the codebook may be transmitted to the Node-B.

The codebook used for channel quantization may consist of N unit-norm vectors, and may be denoted as

C_{WTRU}={c₁, c₂, . . . , c_{N}}. Equation (9)

Each WTRU may normalize its channel h and then choose the closest codebook vector that may represent the channel. The normalization process may lose amplitude information. Only the direction, spatial, or both, signature of the channel may be retained. The amplitude information may be inferred from the CQI feedback. Quantization may be done according to the minimum Euclidian distance such that

$$\begin{matrix}{\hat{h}}_{k} = {c}_{n} , & Equation ( 10 ) \\ n = arg {max}_{i = 1 , … , N} \vert {\tilde{h}}_{k} {c}_{i}^{H} \vert , & Equation ( 11 )\end{matrix}$$

where \tilde{h}ₖ denotes the normalized channel and ĥₖ is the quantized channel. The WTRU may report the index n to the transmitter.

Once a cooperating cell receives the channel information from the WTRUs, it may schedule multiple WTRUs on the same RBG, for example, by using the zero-forcing approach. Alternatively, it may decide to schedule a single WTRU. The precoding vector for the WTRU in single user MIMO (SU-MIMO) mode may be determined by using the channel information.

The signaling of the precoding vectors in the downlink may be extended for use when multiple cells are transmitting to the WTRU. In this case, the dedicated RSs from different cells may be multiplexed in time, frequency, code or a combination of these.

Precoding without Feedback

Feedback from the WTRU to the Node-B may not be required. The beamforming weights may be computed by using long-term channel characteristics measured from the uplink transmission. In this case, the WTRU may not need to send any feedback to the cooperating cells. In time division duplex (TDD) mode, the DL channel state information, such as beamforming weights, may be directly estimated from the UL transmission, taking into account the channel reciprocity in DL and UL.

CQI Channel State Information and Rank Feedback

For proper scheduling, a WTRU may report various types of information to cooperating cells. This information may include quantized CSI, the precoding vector/matrix index, CQI, rank indication, or a combination thereof.

The quantized CSI may be required in order to design the precoding vectors used by the cells for data transmission to the WTRUs. Alternatively, a codebook of precoding vectors may be used, and the WTRU may transmit feedback which includes indices from the codebook. A CQI index may correspond to an index pointing to a value in the CQI table. The CQI index may be defined in terms of a channel coding rate and modulation scheme such as Quadrature Phase Shift Keying (QPSK), and 16 or 64 Quadrature Amplitude Modulation (QAM).

Rank Indication

A rank indicator may denote the number of useful transmission layers. Different definitions for rank are possible in a multi-cell cooperative setting.

Cell-Specific Rank

Cell-specific rank may denote the number of layers transmitted from a cell. For example, one cell may transmit two layers of data to a WTRU while another cell may transmit a single layer.

Network Rank

Network rank may denote the total number of layers transmitted in a cooperation area. For example, each cell may transmit a single layer of data while the layers transmitted from the cells may be different. In this case, the total rank may be equal to the number of the cooperating cells. If each cell transmits on the same layer, then the network rank may be one.

If all cooperating cells transmit the same modulation symbols, then over-the air combining may be possible. In this case, the received signal may be denoted as:

$$y = [ {H}_{1} … {H}_{N} ] [ \begin{matrix}{W}_{1} & … & 0 \\ & ⋱ & \\ 0 & & {W}_{N}\end{matrix} ] [ \begin{matrix}s \\ ⋮ \\ s\end{matrix} ] = {\sum }_{i = 1}^{H} {H}_{i} {W}_{i} s = \tilde{H} s , \qquad Equation ( 12 )$$

where H is the effective channel. This kind of transmission has a network rank of m, where m is the number of data layers in s. When a single layer of data is transmitted, the network rank is one. The network rank may be more than one when multiple layers of data are transmitted. In addition to the rank information, CQI and channel information may be also reported. Different cooperating cells may transmit the same data using different redundant versions, different modulation and coding schemes (MCSs), or both. In the case of cell specific rank, the WTRU may provide the per-cell rank information for the associated cooperating cell. Rank adaptation may be performed per cooperating cell. A central controller, (e.g., a primary cell), may determine the rank for the individual cooperating cell. In multi-cell cooperative MIMO, the number of layers, and therefore the rank, for a cell may be limited to a maximum of two.

For network rank, the WTRU may feed the network rank information, such as a single rank index representing the rank of the cooperating network, back to the cooperating cells.

Single Effective CQI

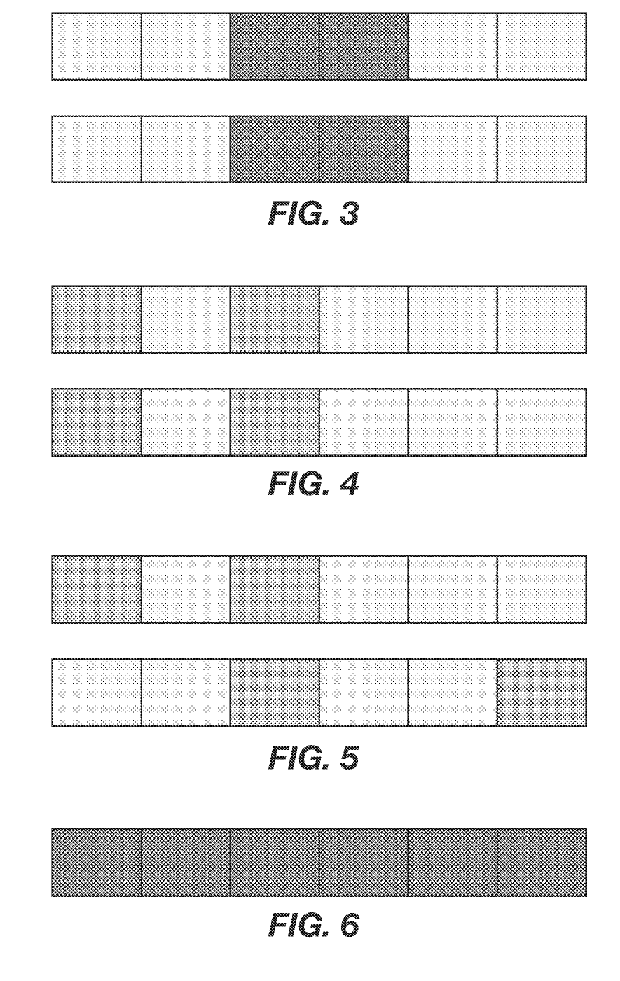

A single effective CQI per RBG may be used. The effective CQI may represent the quality of the effective channel from all cooperating cells. Referring to FIG. 3, the six RBGs in the frequency domain are illustrated for two cooperating cells. The WTRU may compute an effective CQI per RBG. In this computation, the WTRU may assume that both cells transmit to the WTRU on the same RBGs. For example two CQIs may be computed for RBGs 3 and 4.

The received signal by the k′th WTRU on a given subcarrier may be denoted as:

$${y}_{k} = {\sum }_{i = 1}^{N} ( \begin{matrix}\sqrt{{P}_{ki}} {h}_{ki} {w}_{ki} {s}_{ki} + \\ {\sum }_{j = 1 , j \neq k}^{{K}_{i}} \sqrt{{P}_{ji}} {h}_{ki} {w}_{ji} {s}_{ji}\end{matrix} ) + {n}_{k} , \qquad Equation ( 13 )$$

where i denotes the cell index, k denotes the WTRU index, j denotes the index of the WTRUs that are scheduled on the same resources as the k′th WTRU in MU-MIMO mode, and Kᵢ denotes the number of paired WTRUs in multi-cell MU-MIMO mode by the i′th cell.

The signal-to-interference plus noise ratio (SINR) for transmission from the i′th cell then may be denoted as:

$${SINR}_{k , i} = \frac{{P}_{ki} {\vert {h}_{ki} {w}_{ki} \vert}^{2} {E}_{s}}{{N}_{0} + {\sum }_{j = 1 , j \neq k}^{{K}_{i}} {P}_{ji} {\vert {h}_{ki} {w}_{ji} \vert}^{2} {E}_{s} + I} , \qquad Equation ( 14 )$$

where N₀ denotes the noise power, the first interference term is due to any possible inter-user interference in MU-MIMO transmission and the second interference term is due to inter-cell interference.

There may be several approaches to compute an effective SINR. For example, one approach may be to use the ratio of the total received signal power to the total noise and interference power.

There may be many different approaches to compute the effective SINR from which the CQI can be derived. As noted previously, CQI index points to an element in the CQI table. The CQI value represents the composite channel quality for a given resource block.

A single effective CQI may be useful when the transmission to the WTRU from a plurality of cooperating nodes (i.e., transmission points) appears to originate from a single source. For example, this may occur when the cooperating nodes transmit on the same RBGs by using the same coding rate and modulation, and the signals are combined over the air. In this case, each node uses a separate precoding matrix as given in Equation 12. In another case, the cooperating nodes may act as a single transmission point with antennas distributed over the nodes, and a single effective precoding matrix W is designed.

With an effective CQI, the WTRU may report the CQI values, one for each resource block or RBG, and a label that indicates the indices of the RBGs for which the CQIs are computed. The label and the CQI values may be common for all cooperating cells. Therefore, the feedback overhead may be reduced.

Separate but Dependent CQIs Per Cell

Instead of having an effective CQI, the WTRU may also transmit separate CQIs for each, or some, of the cooperating cells, i.e. CQI per cell. In this case, the CQIs may be separate for the cells, but they represent the channel quality on the same RBGs. For example, referring to FIG. 4, the WTRU reports two sets of CQIs for RBGs 1 and 3. The first set contains information about the channel quality from the first cell and the second set contains information about the channel quality from the second cell.

With this kind of CQI reporting, the WTRU may report a separate CQI value for each cooperating cell. The label for the RBGs may be common for all cooperating cells.

Separate but Independent CQIs Per Cell

The WTRU may report CQIs representing the channel quality for different RBGs for each, or some, of the cooperating cells. Referring to FIG. 5, the WTRU reports CQI for RBGs 1 and 3 to cell 1 and reports CQI for RBGs 3 and 6 to cell 2. To keep the overhead the same, the total number of RBGs for which CQI is reported may be maintained. For example, this number could be M in the best-M scheme.

With this kind of CQI, the scheduling may have more flexibility. For example, different cells may transmit to the same WTRU on different RBGs. The WTRU may report a separate CQI value and label for each cooperating cell. This kind of reporting may have the largest feedback overhead.

### Wideband CQI

A wideband CQI may be defined. The wideband CQI may be an effective CQI, as defined above, for all of the RBGs for which CQI reporting is required. Alternatively, a separate wideband CQI for each cooperating cell may be utilized. Referring to FIG. 6, the CQI may represent the channel quality on the whole band.

Channel State Reporting

In addition to the CQI, the WTRU may report the channel state information, the precoding vector/matrix index, or both, for each reported subband. This information may be different for each cooperating cell. Some possible reporting combinations for CQI, CSI and PMI are given in Table 1. Similar to CQI, an effective CSI and per cell CSI can be defined. In per cell CSI, a separate CSI is reported for each cooperating node. In effective CSI, a single effective CSI for the composite channel from the WTRU to the cooperating nodes is defined. For example, CSI for \tilde{H} in Equation 12 is an effective CSI.

As shown below in Table 1, different CSI or PMI feedback approaches exist. These approaches include:
1) No CSI or PMI: the WTRU may not feed back any information about CSI or PMI.
2) Single CSI or PMI: the WTRU may report a single CSI or PMI for all of the reported subbands, providing a wideband CSI or PMI feedback. The reported information is used for all of the subbands. 3) Multiple CSI or PMI: The WTRU reports a separate CSI or PMI value for each of the reported subbands.

In all cases, unlike the CQI feedback, the CSI and PMI feedback may be separate for each cooperating cell. In one scenario, the WTRU may feedback an effective CQI (wideband or subband) and an effective CSI. In another scenario, the WTRU may feedback an effective CQI (wideband or subband) and a per cell CSI. In yet another scenario, the WTRU may feedback a per cell CQI (wideband or subband) and a per cell CSI.

TABLE 1

| | CSI or PMI | | |
|---|---|---|---|
| | No CSI | Single CSI | Multiple CSI |
| | or PMI | or PMI | or PMI |
| Wideband effective CQI | reported subbands may be the same or | | |
| Wideband CQI per cell | different for each cell | | |
| WTRU selected subband | | | |
| effective CQI | | | |
| WTRU selected subband CQI | | | |
| per cell | | | |
| Configured subband effective | | | |
| CQI | | | |
| Configured subband CQI per | | | |
| cell | | | |

Beamforming

One method for inter-cell interference mitigation may be to design the beamforming/precoding vectors used for transmission to a WTRU such that interference on the other WTRUs which share the same resources may be minimized. A WTRU may not receive data from all of the cooperating cells. The cooperating cells may try to minimize the interference on this WTRU.

In one example, assuming that WTRU 1 is served by cell 1 on subband S. Cell 2, which is a neighbor of cell 1, may serve WTRU 2 on the same subband. The channel between WTRU 1 and the two cells is given by h₁ and h₂, respectively. If cell 2 knows h₂, then it may design the beamforming vector used for transmission on subband S such that interference on WTRU 1 is minimized. This kind of operation may require that the CSI information is known. CQI is cell-specific. If the WTRU knows that such an interference mitigation technique may be used, then the reduced inter-cell interference may be considered in the CQI computation.

When codebook based precoding is used, this method may be used with some modifications. In this case, the WTRU may report the preferred precoding vector. In addition to this, the WTRU may also report the indices of the precoding vectors that may result in the minimum interference when used by the neighbor cells for transmission to other WTRUs on the same RBGs. Some possible combinations of feedback for this approach are given in Table 2 below.

TABLE 2

| | CSI (one for each cooperating cell) or | | |
|---|---|---|---|
| | PMI (one for each cooperating cell) | | |
| | No CSI/PMI | Single | Multiple |
| Wideband cell-specific CQI | CQI reported only for the serving cell | | |
| WTRU selected cell-specific | | | |
| subband CQI | | | |
| Configured cell-specific | | | |
| subband CQI | | | |

As shown in Table 2, a separate CSI may be reported for each cooperating node. A single CQI is reported for the serving cell.

CQI Reporting

The CQI report may be achieved with this procedure. A set of subbands, Sᵢ, may be configured by higher layer signaling for the i′^{th} cooperating cell. The set may be the same for all cooperating cells or it may be different for all, or some of the cells. The CQI, PMI/CSI, and rank report may be based on either the subbands in the set Sᵢ or the best-Mᵢ subbands selected from the set Sᵢ on which the WTRU prefers transmission. A CQI and CSI/PMI combination from Table 1 or Table 2 may be fed back to the serving Node-B. The combination may be configured semi-statistically.

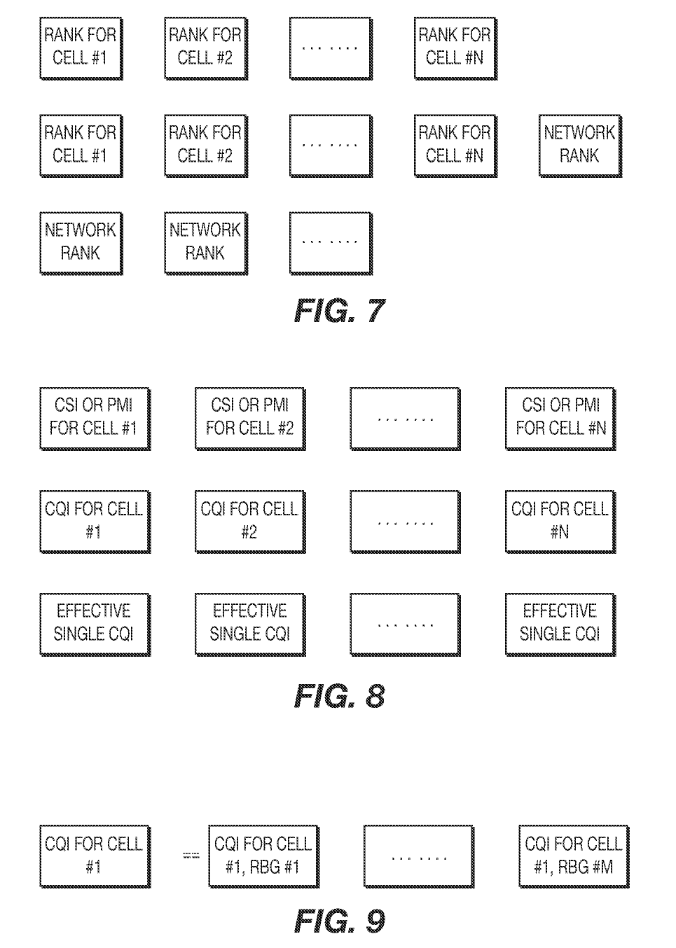

The CQI, CSI/PMI, and rank information may be fed back to the cooperating cells periodically, aperiodically, or both. The physical uplink control channel (PUCCH) and the physical uplink shared channel (PUSCH) may be used for this purpose. These parameters may be transmitted in different fashions when periodic reporting is being used. As an example, the WTRU may only report the network rank when the cell-specific ranks are fixed, for example, when they are always one. Alternatively, cell-specific ranks only or cell-specific ranks and the network rank may be reported. Some examples for possible reporting mechanisms are illustrated in FIG. 7. Note that the periodicities and the order of reporting the different rank types in FIG. 7 are for illustration purposes only. Different combinations of reporting are possible.

Similar concepts can be applied to CSI/PMI and CQI feedback. The CSI/PMI for cooperating cells may be reported sequentially. Some sample reporting mechanisms are illustrated in FIG. 8. A CSI/PMI or CQI reporting instance, as illustrated in FIG. 8, might consist of reporting these values for different subbands as illustrated in FIG. 9, such as subbands in set S or best-M subbands, or wideband reporting. Reporting may also be done as a result of a request from the Node-B.

Distributed Space Time/Frequency Coding with Multi-Cell Cooperation

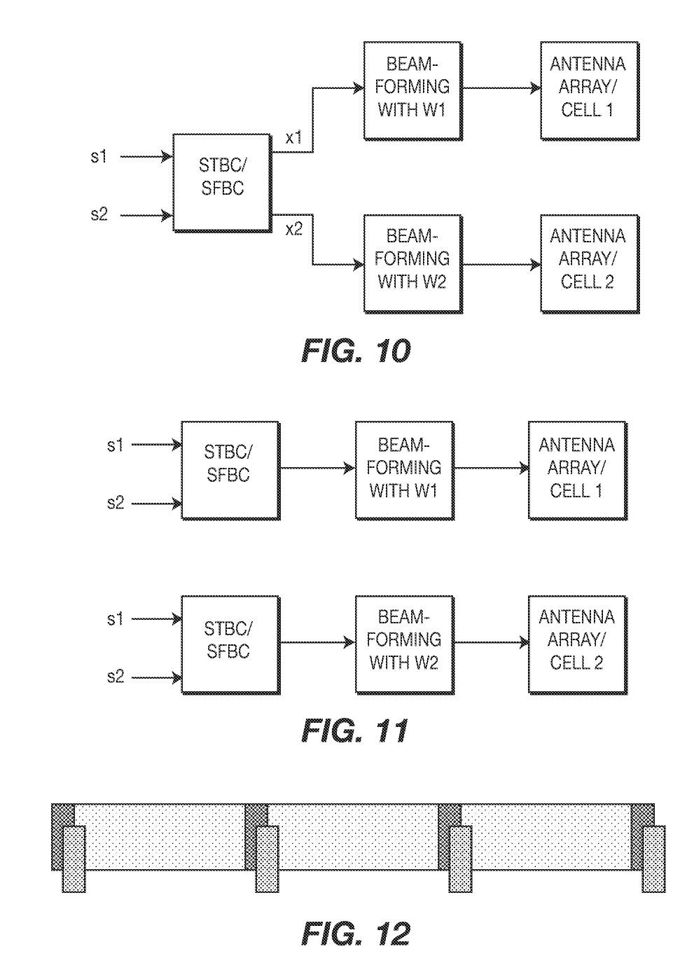

Space time coding, frequency coding, or both may be used with multi-cell cooperation to improve performance. One approach may be to combine beamforming with space time coding, frequency coding, or both, as illustrated in FIG. 10, where two cooperating cells are assumed.

Data that is space-time coded, space-frequency coded, or both, may be multiplexed into the cooperating cells and then transmitted by using beamforming.

A beamforming vector may be equal to identity, such that there is no beamforming. In this case, one symbol from the code is transmitted by a different cell.

As an alternative, space-frequency block coding (SFBC) or space-time block coding (STBC) may be used separately at each cell, as illustrated in FIG. 11. In this case, each cell may transmit the same modulation symbols after applying SFBC or STBC. The WTRU may receive the data from multiple transmission points. This operation may be transparent to the WTRU. The WTRU may only experience a power gain. This kind of transmission may be used to improve the link reliability, for example for the control channel. Similarly, the beamforming vector may be set to identity, such that, no beamforming is applied.

HARQ Operation

When several cells are cooperatively transmitting the same information to a WTRU, two kinds of transmission may be possible. The cells may send the same data by using the same modulation, MCS, scrambling, and the like. This kind of transmission may be advantageous when there is a single effective CQI representing the composite transmission. In this case, the signals from the cooperating cells may be combined over the air.

In addition, the cooperating cells may send different redundancy versions of the same information bits. In this case, the WTRU receiver may need to process each transmission to get the soft bits. Combining may be achieved on soft bit level. This type of communication may be advantageous where separate CQI reports are provided for cooperating cells.

The WTRU may send one positive acknowledgement (ACK) message or negative acknowledgment (NACK) message for each HARQ process. The ACK/NACK may be received by all, or some of, the cooperative cells. The manner in which the received multiple replicas of the ACK/NACK are combined in the cooperating network may depend on the network architecture in UL. For example, if the network architecture is decentralized, the individual cooperating nodes may decode the received ACK/NACK separately and pass the ACK/NACK result to a primary cell which combines all the ACK/NACK results. Alternatively, if the architecture is centralized, all the ACK/NACK replicas received from the cooperating cells may be passed to a central controller, or cell, which combines the ACK/NACK replicas coherently, or noncoherently.

Downlink Control Signaling

Signaling with Control Channel and Dedicated Reference Signals

The signaling of the precoding vectors from a single cell by using the control channel or dedicated reference signals may be applied when there are multiple cells cooperating. When multiple cells are cooperating to transmit data to a WTRU, and this transmission is such that the data streams from different cells may need to be separated (such as when cells are transmitting different data streams or different redundancy versions of the same data), then the precoding vector used by each cell may be signaled to the WTRU.

When dedicated reference signals are used, different cells may multiplex these pilots in frequency, time, or by using different codes.

Same Resource Element Transmission

Dedicated reference signals from cooperating cells may be transmitted on the same resource elements. The WTRU may estimate the effective channel and use it for receiving the transmitted data.

### Zero-Forcing Beamforming

When the control channel is used to signal the precoding vectors for zero-forcing beamforming, methods of downlink control signaling for zero-forcing beamforming and unitary precoding for MU-MIMO may be used. The data corresponding to the cooperating multiple cells may be transmitted in the same control packet data.

When the control channel is used to signal the precoding vectors for a codebook based approach, such as unitary precoding, the WTRU selection may be accepted or overridden. When the WTRU selection is accepted, a confirmation may be sent. When the WTRU selection is overridden, the new precoding vector may be transmitted. A control channel packet that contains this information for multiple cooperating cells may be used.

Multi-Cell MIMO Precoding for the Control Channel

When two or more cells are cooperating to transmit data to two or more WTRUs, then the same beamforming vectors can be used to transmit the control channel data as well. When beamforming is used, the WTRU should learn which beamforming vectors have been used to correctly decode the received signal. For the data transmission this could be achieved by two methods. In one method, the WTRU decodes the control channel. The control channel contains information about the resource allocation for the data transmission and the used beamforming vectors. In the other method, the WTRU decodes the control channel. The control channel contains information about the resource allocation for the data transmission. The beamforming weights are signaled by using dedicated reference signals in fixed locations of the allocated resource blocks.

When the control channel is transmitted by beamforming, however, the WTRU may not have any information about the beamforming vector. Therefore the WTRU cannot decode the control channel without knowledge of the beamforming vector. In addition, the subcarriers allocated to the control channel might be interleaved over a large frequency band. The control data can be transmitted from one or more transmission points.

The transmission points may be defined as a number of transmit antennas which make a joint transmission. For example, two RRUs, each with a single antenna can be considered as a single transmission point with two antennas. In this case, the weights of the beamforming vectors are distributed over all antennas.

Alternatively, the transmission points may also be defined as a transmitter with multiple antennas. For example, two RRUs, each with multiple antennas. In this case, the RRUs use different beamforming vectors but send the same data to the same WTRU.

Similar to data transmission, the control data is also transmitted on the same resource elements for multiple WTRUs. As an example, FIG. 12 illustrates four resource elements in an orthogonal frequency division multiplexing (OFDM) symbol where each resource element carries part of the control data for two WTRUs. The separation between the control data of the different WTRUs is achieved in the spatial domain by using different beamforming vectors.

The beamforming vector needs to be signaled to the WTRU. This can be achieved with several techniques.

Control channel is decoded blindly by using the cyclic redundancy check (CRC) which is formed by using the WTRU ID. A WTRU tries all or a set of possible control channels until getting the correct WTRU ID from the CRC. There can be predefined locations associated with each control channel, (i.e., subcarriers in frequency and time), which can be reserved for dedicated reference signals. The dedicated reference signals are known reference signals precoded with the used beamforming vector. These subcarriers are not used to carry any information. When a WTRU tries to decode a control channel, it uses the dedicated reference signals in the locations reserved for that control channel. From these dedicated reference signals, the effective channel is estimated and used to decode the control channel. When two or more WTRUs share the same control channel, as in multi-cell MIMO, separate dedicated reference signals should be sent for those WTRUs. In this case, more subcarriers should be reserved to carry the different dedicated reference signals.

It is possible that a codebook based approach is used for multi-cell MIMO. In this case, the WTRU selects the preferred beamforming vectors from a codebook and the Node-B uses those vectors for data transmission. The same vectors are also used for control channel transmission. If the Node-B decides that the reported vectors are not reliable, two techniques can be used. In the first technique, control data is transmitted without precoding. In this case, the WTRU has to try to decode the control channel with and without using the reported beamforming vectors. In the second technique, even with a codebook based approach, dedicated reference signals can be used as in the previous technique.

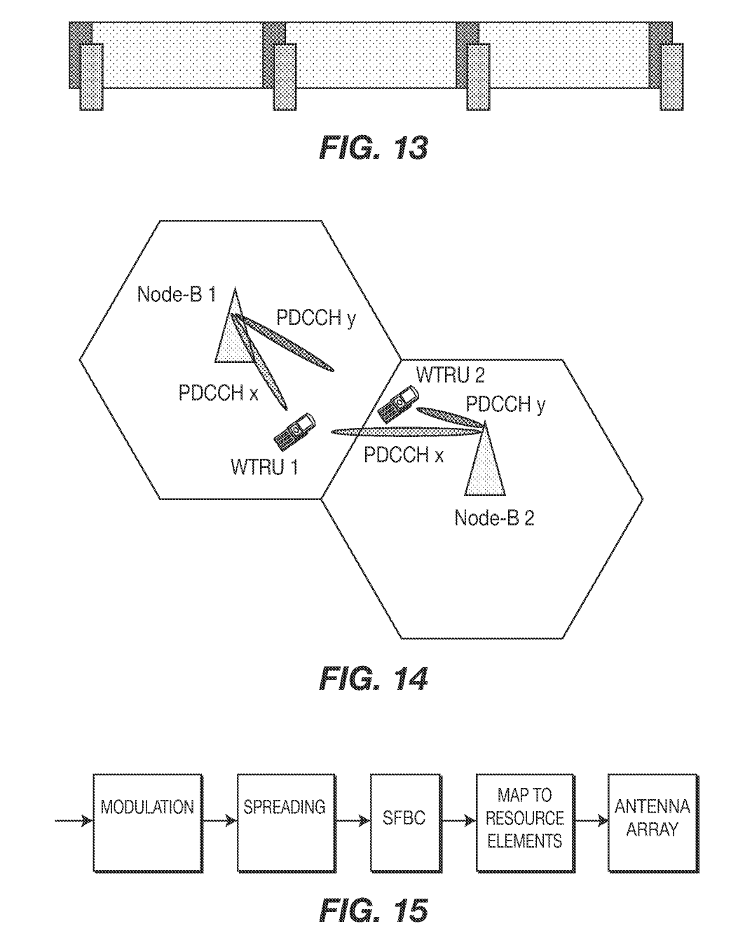

When the transmitter computes the beamforming vectors from the uplink transmission and does not use any feedback from the WTRU, the methods in the first technique can be similarly used. Dedicated reference signals from cooperating cells can be transmitted on different resource elements or on the same resource elements. It is possible that the control channels of two WTRUs to have different sizes. For example, in FIG. 13, different shadings indicate subcarriers for different WTRUs. A PDCCH can be formed by combining 1, 2, 4, or 8 consecutive CCEs. For example, a PDCCH can consist of CCE1; CCE1-CCE2; CCE1 . . . CCE4; CCE3-CCE4, and the like. Therefore, it is also possible to have predefined locations associated with each CCE which are reserved for dedicated reference signals.

Common Control Space

The number of blind detections and overhead for dedicated reference signals can be reduced by defining a set of CCEs or control channel candidates that are reserved for WTRUs in multi-cell cooperation mode only. The set of CCEs or control channel candidates then constitute a common control search space only for the WTRUs which are in multi-cell cooperation mode. The WTRUs in cooperation mode receive their control channel transmissions in this common control channel area.

Inter-Cell Interference Coordination

The interference on the control channel can be reduced by using inter-cell interference coordination techniques. Assuming that a common control search space consists of predefined CCEs, and this control space is used for cell-edge WTRUs that are in multi-cell cooperation mode, neighbor cells can use different common control search spaces. This information can be exchanged among the cells or is known at the central controller.

To reduce the inter-cell interference, one control search space used in a cell for cell-edge WTRUs can be used for cell-center WTRUs in the neighbor cells where the power transmitted on this search space is reduced. Alternatively, the power transmitted on the control search space used for cell-edge WTRUs can be increased. With this technique, the performance of the control channel of cell-edge WTRUs can be improved.

An extension to this method is that the search space for cell-edge WTRUs in a cell may not be used by the neighbor cells. In this case, to be able to continue serving the same number of WTRUs, the resources used for control channel transmission should be increased resulting in an increase of the overhead. The overhead can be kept the same or minimized if cells are defined with a smaller number of WTRUs.

Multicast Control Channel

A multicast control channel may be defined where there is a control channel that carries the common information for WTRUs in multi-cell or MU-MIMO mode. One common information is the resource allocation. Assuming that these WTRUs will have similar CQIs, then the same MCS can also be used for them. This can be achieved in two ways. In one way, each WTRU may continue to receive a separate PDCCH. In addition to the separate PDCCH, there is also a common control channel that is transmitted to this WTRU and several other WTRUs. The WTRU tries to blindly decode both control channels. The common control channel is masked with an ID that is known to the WTRUs in the cooperation mode. Alternatively, a different control channel format which carries the different and common information for WTRUs in cooperation mode may be defined. For example, if there are two WTRUs, the control channel can contain an MCS for the first WTRU, an MCS for the second WTRU, and a resource allocation. This control channel is masked with an ID that is known by both of the WTRUs. In this case, the WTRUs also need to know the order of the different information. This can be achieved by implicitly mapping the order of this information to another parameter.

Null Steering

It is also possible that each cell transmits the control channel to its WTRUs independently. In this case, the control channel is transmitted only from the serving cell to the WTRU, although a data channel may be transmitted cooperatively. However, a cooperating cell can use available information about the CSI of the WTRU to design the beamforming/precoding vectors for its own WTRUs, such that interference on the control channel of this WTRU is minimized.

Transmission of the Control Channel with Transmit Diversity and Beamforming

The control channel can be transmitted with a combination of transmit diversity only and transmit beamforming. The two approaches can be multiplexed in time. For example, in the first TTI, control channel is transmitted with transmit diversity only. In this TTI, the used beamforming vector can also be signaled. Then, for the next consecutive n TTIs, the same beamforming vector can be used. The WTRU can try to decode the control channel with and without the beamforming vector when there is an uncertainty about the beamforming vector used.

Wideband Precoding

When frequency selective beamforming/precoding is used, the reserved dedicated reference signals are precoded with the beamforming vector for that frequency band. One problem with this approach is that the WTRU might not feed back the channel information about the whole band, but only for a subset of the bands. Then, beamforming the CCEs that are interleaved over the whole band is a challenge. Two methods can address this problem. In a first method, the control channel can be localized as data. Thus, a new control channel structure can be designed. This approach could have some backward compatibility problems. Alternatively, the control channel can be beamformed/precoded by using a wideband beam. Note that, with closely spaces antennas, this would the most common approach.

Spreading for the Control Channel

The performance of control channel can be improved when two or more cooperating cells transmit the same control channel data to the same WTRU. For example, in FIG. 14, two cooperating cells use the same physical downlink control channel, PDCCH x, to transmit the control data to WTRU 1 and PDCCH y to transmit control data to WTRU 2. This kind of transmission increases the received power for the WTRUs and eliminates the inter-cell interference. The disadvantage of such as scheme is that the amount of required subcarriers for control channel increase because each cell uses the same resources for a single WTRU. For example, when there is no cooperation, cell 2 can use PDCCH x for one of its own WTRUs. With cooperation, cell 2 needs to use another control channel for this WTRU.

As previously described, the resource usage efficiency can be improved by using the same resources for PDCCHs x and y and differentiating them in the spatial domain, for example, by using beamforming.

Another method is to separate WTRUs in the code domain by using spreading. In this method, a WTRU is allocated a spreading sequence. The control data for the WTRU is first coded, for example, by using SFBC. Then, the data is spread with a predetermined sequence. After this, the data is mapped to the physical resources of the control channel being used. The control channel data of several WTRUs can be transmitted by the cooperating cells by using different spreading sequences for different WTRUs. So, in this case, separation between the WTRUs is not in the spatial domain but in the code domain. The procedure is illustrated in FIG. 15. The incoming control data can be modulated and then spread with a spreading sequence. Then, space time/frequency coding can be applied to the sequence and mapped to the resource elements.

The length of the spreading sequence can be fixed and determined before or adaptively changed. To achieve a better performance, orthogonality of the sequences need to be preserved. Thus, if spreading is done over subcarriers in a frequency-selective channel or OFDM symbols in a time-selective channel, optimum performance might not be achieved. To solve this problem, x adjacent time/frequency bins can be used to transmit a spread sequence where x is the length of the spreading sequence.

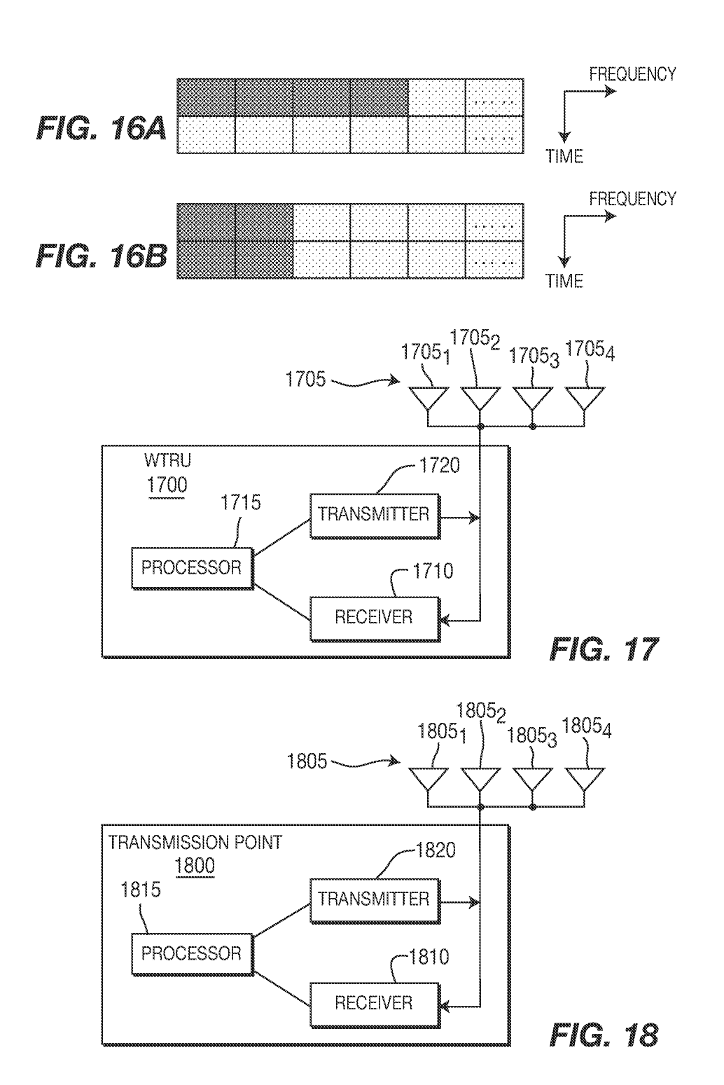

For example, FIGS. 16A and 16B show which time/frequency bins (subcarriers) can be used for transmission of a spread sequence where x is 4. Scenario “a” shows the possibility of transmitting the spread sequence in the frequency domain. Scenario “b” shows the possibility of transmitting the spread sequence in both time and frequency domains. The number of blind detections might increase due to the spreading code, but this can be reduced by using the previously described techniques, or by some semi-static configuration.

FIG. 17 is a block diagram of a WTRU 1700. The WTRU 1700 includes a MIMO antenna 1705, a receiver 1710, a processor 1715, a transmitter 1720 and a memory 1725. The MIMO antenna 1705 includes antenna elements 1705₁, 1705₂, 1705₃ and 1705₄.

FIG. 18 is a block diagram of a transmission point 1800. The transmission point 1800 includes a MIMO antenna 1805, a receiver 1810, a processor 1815, a transmitter 1820 and a memory 1825. The MIMO antenna 1805 includes antenna elements 1805₁, 1805₂, 1805₃ and 1805₄.

The WTRU 1700 provides feedback of channel quality associated with channels from a plurality of transmission points 1800.

The processor 1715 in the WTRU 1700 may be configured to determine a particular wideband effective CQI for each of a plurality of RBGs. The transmitter 1720 in the WTRU 1700 may be configured to transmit a particular wideband effective CQI value and a label that indicates indices of the RBGs. The transmission points may be cooperating cells that transmit the same data on the same RBGs, and use the same coding rate and modulation. The transmission points may be transmit antennas or transmitters with multiple antennas.

The processor 1715 in the WTRU 1700 may be configured to determine a set of effective CQIs, each effective CQI corresponding to a plurality of RBGs. The transmitter 1720 in the WTRU 1700 may be configured to transmit a set of effective CQI values and a label that indicates indices of the particular RBGs.

The processor 1715 in the WTRU 1700 may be configured to determine at least one effective CQI and at least one effective CSI corresponding to a plurality of RBGs. The transmitter 1720 in the WTRU 1700 may be configured to transmit at least one effective CQI value, at least one effective CSI value, and a label that indicates indices of the RBGs.

The processor 1715 in the WTRU 1700 may be configured to determine at least one effective CQI and at least one CSI for each transmission point that corresponds to a plurality of RBGs. The transmitter 1720 in the WTRU 1700 may be configured to transmit at least one effective CQI value and at least one CSI value for each transmission point, and a label that indicates indices of the RBGs.

The processor 1715 in the WTRU 1700 may be configured to determine at least one CQI and at least one CSI for each transmission point that corresponds to a plurality of RBGs. The transmitter 1720 in the WTRU 1700 may be configured to transmit at least one CQI value and at least one CSI value for each transmission point, and a label that indicates indices of the RBGs.

The processor 1715 in the WTRU 1700 may be configured to determine a particular wideband CQI for each of the transmission points that correspond to RBGs. The transmitter 1720 in the WTRU 1700 may be configured to transmit a particular wideband CQI value for each transmission point and a label that indicates indices of the RBGs.

The processor 1715 in the WTRU 1700 may be configured to determine a set of CQIs for each of the transmission points, wherein each CQI in the set corresponds to a particular RBG. The transmitter 1720 in the WTRU 1700 may be configured to transmit a set of CQI values for each transmission point and a label that indicates indices of the particular RBGs.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method, performed by a wireless transmit/receive unit (WTRU), for providing feedback of channel quality associated with channels from a plurality of transmission points, the method comprising:
the WTRU determining a particular wideband effective channel quality indicator (CQI) for each of a plurality of resource block groups; and
the WTRU transmitting a particular wideband effective CQI value and a label that indicates indices of the resource block groups.

2. The method of claim 1 wherein the transmission points are cooperating cells that transmit the same data on the same resource block groups, and use the same coding rate and modulation.

3. The method of claim 1 wherein the transmission points are transmit antennas.

4. The method of claim 1 wherein the transmission points are transmitters with multiple antennas.

5. A method, performed by a wireless transmit/receive unit (WTRU), for providing feedback of channel quality associated with channels from a plurality of transmission points, the method comprising:
the WTRU determining a set of effective channel quality indicators (CQIs), each effective CQI corresponding to a plurality of resource block groups; and
the WTRU transmitting a set of effective CQI values and a label that indicates indices of the particular resource block groups.

6. The method of claim 5 wherein the transmission points are cooperating cells that transmit the same data on the same resource block groups, and use the same coding rate and modulation.

7. The method of claim 5 wherein the transmission points are transmit antennas.

8. The method of claim 5 wherein the transmission points are transmitters with multiple antennas.

9. A method, performed by a wireless transmit/receive unit (WTRU), for providing feedback of channel quality and channel state information (CSI) associated with channels from a plurality of transmission points, the method comprising:
the WTRU determining at least one effective channel quality indicator (CQI) and at least one effective CSI corresponding to a plurality of resource block groups; and
the WTRU transmitting at least one effective CQI value, at least one effective CSI value, and a label that indicates indices of the resource block groups.

10. A method, performed by a wireless transmit/receive unit (WTRU), for providing feedback of channel quality and channel state information (CSI) associated with channels from a plurality of transmission points, the method comprising:
the WTRU determining at least one effective channel quality indicator (CQI) and at least one CSI for each transmission point that corresponds to a plurality of resource block groups; and
the WTRU transmitting at least one effective CQI value and at least one CSI value for each transmission point, and a label that indicates indices of the resource block groups.

11. A method, performed by a wireless transmit/receive unit (WTRU), for providing feedback of channel quality and channel state information (CSI) associated with channels from a plurality of transmission points, the method comprising:
the WTRU determining at least one channel quality indicator (CQI) and at least one CSI for each transmission point that corresponds to a plurality of resource block groups; and
the WTRU transmitting at least one CQI value and at least one CSI value for each transmission point, and a label that indicates indices of the resource block groups.

12. A method, performed by a wireless transmit/receive unit (WTRU), for providing feedback of channel quality associated with channels from a plurality of transmission points, the method comprising:
the WTRU determining a particular wideband channel quality indicator (CQI) for each of the transmission points that correspond to resource block groups; and
the WTRU transmitting a particular wideband CQI value for each transmission point and a label that indicates indices of the resource block groups.

13. A method, performed by a wireless transmit/receive unit (WTRU), for providing feedback of channel quality associated with channels from a plurality of transmission points, the method comprising:
the WTRU determining a set of channel quality indicators (CQIs) for each of the transmission points, wherein each CQI in the set corresponds to a particular resource block group; and
the WTRU transmitting a set of CQI values for each transmission point and a label that indicates indices of the particular resource block groups.

14. A wireless transmit/receive unit (WTRU) for providing feedback of channel quality associated with channels from a plurality of transmission points, the WTRU comprising:
a processor configured to determine a particular wideband effective channel quality indicator (CQI) for each of a plurality of resource block groups; and
a transmitter configured to transmit a particular wideband effective CQI value and a label that indicates indices of the resource block groups.

15. The WTRU of claim 14 wherein the transmission points are cooperating cells that transmit the same data on the same resource block groups, and use the same coding rate and modulation.

16. The WTRU of claim 14 wherein the transmission points are transmit antennas.

17. The WTRU of claim 14 wherein the transmission points are transmitters with multiple antennas.

18. A wireless transmit/receive unit (WTRU) for providing feedback of channel quality associated with channels from a plurality of transmission points, the WTRU comprising:
a processor configured to determine a set of effective channel quality indicators (CQIs), each effective CQI corresponding to a plurality of resource block groups; and
a transmitter configured to transmit a set of effective CQI values and a label that indicates indices of the particular resource block groups.

19. The WTRU of claim 18 wherein the transmission points are cooperating cells that transmit the same data on the same resource block groups, and use the same coding rate and modulation.

20. The WTRU of claim 18 wherein the transmission points are transmit antennas.

21. The WTRU of claim 18 wherein the transmission points are transmitters with multiple antennas.

22. A wireless transmit/receive unit (WTRU) for providing feedback of channel quality and channel state information (CSI) associated with channels from a plurality of transmission points, the WTRU comprising:
a processor configured to determine at least one effective channel quality indicator (CQI) and at least one effective CSI corresponding to a plurality of resource block groups; and
a transmitter configured to transmit at least one effective CQI value, at least one effective CSI value, and a label that indicates indices of the resource block groups.

23. A wireless transmit/receive unit (WTRU) for providing feedback of channel quality and channel state information (CSI) associated with channels from a plurality of transmission points, the WTRU comprising:
a processor configured to determine at least one effective channel quality indicator (CQI) and at least one CSI for each transmission point that corresponds to a plurality of resource block groups; and
a transmitter configured to transmit at least one effective CQI value and at least one CSI value for each transmission point, and a label that indicates indices of the resource block groups.

24. A wireless transmit/receive unit (WTRU) for providing feedback of channel quality and channel state information (CSI) associated with channels from a plurality of transmission points, the WTRU comprising:
a processor configured to determine at least one channel quality indicator (CQI) and at least one CSI for each transmission point that corresponds to a plurality of resource block groups; and
a transmitter configured to transmit at least one CQI value and at least one CSI value for each transmission point, and a label that indicates indices of the resource block groups.

25. A wireless transmit/receive unit (WTRU) for providing feedback of channel quality associated with channels from a plurality of transmission points, the WTRU comprising:
a processor configured to determine a particular wideband channel quality indicator (CQI) for each of the transmission points that correspond to resource block groups; and
a transmitter configured to transmit a particular wideband CQI value for each transmission point and a label that indicates indices of the resource block groups.

26. A wireless transmit/receive unit (WTRU) for providing feedback of channel quality associated with channels from a plurality of transmission points, the WTRU comprising:
a processor configured to determine a set of channel quality indicators (CQIs) for each of the transmission points, wherein each CQI in the set corresponds to a particular resource block group; and
a transmitter configured to transmit a set of CQI values for each transmission point and a label that indicates indices of the particular resource block groups.
